(19) United States
(12) Patent Application Publication
(10) Pub. No.: US 2026/0287346 A1
(43) Pub. Date: Sep. 24, 2026

(54) Rotary Laser having a Contact Element

(71) Applicant: Robert Bosch GmbH, Stuttgart (DE)

(72) Inventors: Markus Hahl, Korntal-Muenchingen (DE); Tobias Roehm, Wildberg-Sulz (DE); Christian Sels, Stuttgart (DE)

(21) Appl. No.: 19/567,102

(22) Filed: Mar. 14, 2026

(30) Foreign Application Priority Data
Mar. 20, 2025 (DE) 10 2025 110 731.9

(51) Int. Cl. G01C 9/06; G01B 11/26; G01D 11/24; H02K 7/14

(52) U.S. Cl. CPC G01C 9/06; G01B 11/26; G01D 11/245; H02K 7/145; G01C 2009/066

(57) ABSTRACT

A rotary laser includes a housing in which a base plate fixed to the housing is arranged at a predetermined distance from a carrier plate. The carrier plate has a laser assembly. The laser assembly includes at least one laser unit for generating a laser beam and a leveling unit with at least one inclination adjustment unit for adjusting an inclination angle of the carrier plate relative to the base plate fixed to the housing. An end stop unit with at least one contact element is provided, which is designed to deactivate the inclination adjustment unit when a maximum possible inclination angle is reached. The at least one contact element is electrically conductive.

This application claims priority under 35 U.S.C. § 119 to patent application no. DE 10 2025 110 731.9, filed on Mar. 20, 2025 in Germany, the disclosure of which is incorporated herein by reference in its entirety.

### BACKGROUND

The present disclosure relates to a rotary laser having a housing in which a base plate fixed to the housing is arranged at a predetermined distance from a carrier plate, wherein the carrier plate has a laser assembly, wherein the laser assembly has at least one laser unit for generating a laser beam and a leveling unit with at least one inclination adjustment unit for adjusting an inclination angle of the carrier plate relative to the base plate fixed to the housing, and wherein an end stop unit with at least one contact element is provided, which is designed to deactivate the inclination adjustment unit when a maximum possible inclination angle is reached.

The prior art discloses such a rotary laser with a housing in which a base plate fixed to the housing is arranged at a predetermined distance from a carrier plate. The carrier plate has a laser assembly, wherein the laser assembly has at least one laser unit for generating a laser beam and a leveling unit with at least one inclination adjustment unit for adjusting an inclination angle of the carrier plate relative to the base plate fixed to the housing. Furthermore, an end stop unit is provided with at least one contact element, which is designed to deactivate the inclination adjustment unit when a maximum possible inclination angle is reached.

### SUMMARY

The disclosure relates to a rotary laser with a housing in which a base plate fixed to the housing is arranged at a predetermined distance from a carrier plate, wherein the carrier plate has a laser assembly, and wherein the laser assembly comprises at least one laser unit for generating a laser beam and a leveling unit with at least one inclination adjustment unit for adjusting an inclination angle of the carrier plate relative to the base plate fixed to the housing. An end stop unit with at least one contact element is provided, which is designed to deactivate the inclination adjustment unit when the maximum possible inclination angle is reached. The at least one contact element is electrically conductive.

The disclosure thus enables the provision of a rotary laser in which the inclination adjustment unit can be easily and simply deactivated when a maximum possible inclination angle is reached by way of at least one electrically conductive contact element.

Preferably, the at least one contact element is elastically deformable in the event of an overload to protect the laser assembly.

This makes it easy and uncomplicated to prevent destruction of the laser assembly due to overloading.

Preferably, a housing associated with the carrier plate has a recess on its top side associated with the at least one contact element for partially penetrating and contacting a contact surface associated with a control board, whereby a motor associated with the at least one inclination adjustment unit can be deactivated.

This provides a simple way of contacting the inclination adjustment unit to deactivate it.

Preferably, the contact surface is designed as a meander contact.

This makes it easy and uncomplicated to provide a suitable contact surface.

Preferably, the at least one contact element is deformable and electrically conductive at least in sections.

This means that a suitable contact element can be provided simply and easily.

Preferably, the at least one contact element has a cuboid base body with rounded corners and/or is curved along its longitudinal extension.

This makes it easy to design a suitable embodiment for the at least one contact element.

Preferably, the at least one contact element is glued into an associated recess in the base plate fixed to the housing. Alternatively, at least one contact element is arranged on the base plate fixed to the housing by way of a transfer molding process or injection molding process.

This enables a robust and stable arrangement of the at least one contact element on the housing-fixed base plate.

The at least one contact element is preferably aligned along the main axes assigned to the base plate fixed to the housing.

This enables a simple and uncomplicated arrangement of the at least one contact element.

Preferably, two inclination adjustment units are provided and four contact surfaces are provided, wherein two contact surfaces are arranged on a common radial axis with one inclination adjustment unit each, wherein the respective contact surface and the inclination adjustment unit are arranged at a distance from each other in the radial direction.

This safely and reliably prevents the laser assembly from being destroyed in the event of an overload.

Preferably, a motor assigned to at least one inclination adjustment unit is designed such that, when a maximum possible inclination angle is reached, the direction of rotation of the assigned motor can be changed to reduce the inclination angle.

This is a simple alternative way of preventing the laser assembly from being destroyed in the event of an overload.

### BRIEF DESCRIPTION OF THE DRAWINGS

The disclosure is explained in more detail in the following description with reference to the exemplary embodiments shown in the drawings. They show:

FIG. 1 a perspective view of a rotary laser according to the disclosure,

FIG. 2 a perspective view of a laser assembly associated with the rotary laser of FIG. 1 with a base plate,

FIG. 3 a perspective view of the laser assembly of FIG. 2,

FIG. 4 a cross-sectional view of the rotary laser of FIG. 1 with the laser assembly of FIG. 2 and FIG. 3 at a first inclination angle,

FIG. 5 a cross-sectional view of the rotary laser of FIG. 1 with the laser assembly of FIG. 2 and FIG. 3 at a further inclination angle,

FIG. 6 an exploded view of an inclination adjustment unit of the rotary laser of FIG. 1 and FIG. 4 and FIG. 5,

FIG. 7 a cross-sectional view of the inclination adjustment unit of FIG. 6 in a first position,

FIG. 8 a cross-sectional view of the inclination adjustment unit of FIG. 6 in a further position,

FIG. 9 a perspective view of a guide part associated with the inclination adjustment unit of FIG. 6 and FIG. 7,

FIG. 10 a cross-sectional view of the inclination adjustment unit of FIG. 6 and FIG. 7 to illustrate a bayonet connection,

FIG. 11 a cross-sectional view of an alternative inclination adjustment unit in a first position,

FIG. 12 a cross-sectional view of an alternative inclination adjustment unit of the rotary laser of FIG. 1 and FIG. 4 and FIG. 5, in a further position,

FIG. 13 a cross-sectional view of an arrangement of a motor of the inclination adjustment unit associated with the inclination adjustment unit of FIG. 11,

FIG. 14 an exploded view of another inclination adjustment unit of the rotary laser of FIG. 1 and FIG. 4 and FIG. 5,

FIG. 15 a cross-sectional view of the inclination adjustment unit of FIG. 13 in a first position,

FIG. 16 a cross-sectional view of the inclination adjustment unit of FIG. 13 in a second position,

FIG. 17 a cross-sectional view of the inclination adjustment unit of FIG. 13 in a further position,

FIG. 18 a perspective view of the base plate of FIG. 2,

FIG. 19 a top view of the laser assembly of FIG. 2 and FIG. 3,

FIG. 20 a cross-sectional view of the laser assembly of FIG. 2, FIG. 3, FIG. 19 with the base plate of FIG. 2 and FIG. 18, and

FIG. 21 a perspective view of a contact element of the laser assembly of FIG. 2, FIG. 3, FIG. 19 and FIG. 20.

### DETAILED DESCRIPTION

Elements having the same or a comparable function are provided with the same reference signs in the figures and are described in detail only once.

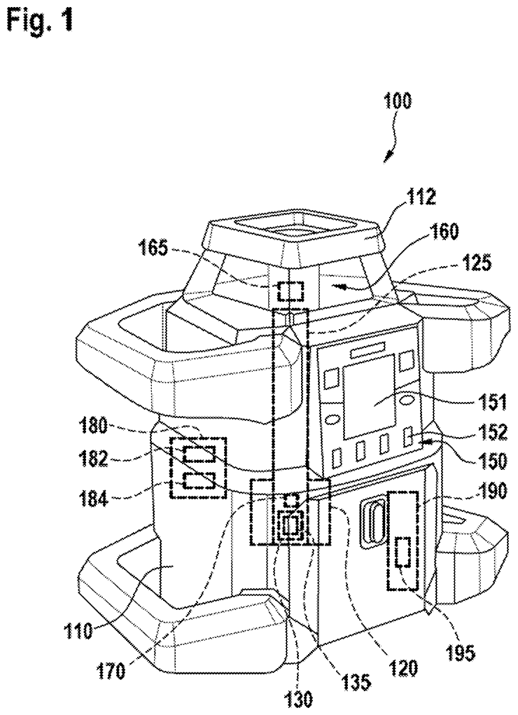

FIG. 1 illustrates an exemplary rotary laser 100 with a housing 110, in which a laser unit 130 with a laser diode 135 for generating a laser beam is arranged. A “rotary laser” may also be understood in the context of the present disclosure to mean a construction laser or a leveling laser. Furthermore, an example of a drive unit 120 for rotating a spindle 125 is arranged in the housing 110. The drive unit 120 is preferably configured as an electric motor.

The laser unit 130 is illustratively arranged on the spindle 125 such that rotation of the spindle 125 rotates the laser beam generated by the laser unit 130 in an associated plane. To this end, the spindle 125 is preferably associated with a rotary head 160 with a beam diverter 165. The beam diverter 165 is preferably configured to deflect the laser beam, as a result of which the laser beam projects the associated plane. Depending on the design of the rotary laser 100, the projected plane may be horizontal, vertical, or, e.g., at a defined inclination angle with respect to the earth's surface.

Moreover, an electronic unit 190 with a control and monitoring device 195 is preferably arranged in the housing 110. The control and monitoring device 195 is preferably configured to control the laser output of the laser unit 130 depending on a mode of operation in each case. A rotational speed of the spindle 125 of the drive unit 120 is thus controlled or regulated. Preferably, a determination unit 170 is associated with the spindle 125 for this purpose.

By way of example, a cage 112 associated with the rotary head 160 is associated with the housing 110 to protect the rotary head 160 from being struck.

The electronic unit 190 is illustratively associated with an operating unit 150 with a display 151 and an input unit 152. The operating unit 150 is preferably connected to the electronic unit 190, in particular to the control and monitoring device 195, for control or regulation purposes. The input unit 152 preferably comprises at least one keypad. Alternatively, the input unit 152 may comprise a rotary control, a touch screen, a slider, a remote control or the like. For example, via the input unit 152, a user may enter a rotational speed for the spindle 125. Alternatively, the rotational speed of the laser unit 130 can be controlled automatically in at least one operating mode.

Preferably, the rotary laser 100 has at least one inclination sensor 184 which is designed to determine an inclination of the rotary head 160, in particular the beam diverter 165, and/or the laser unit 130 with respect to a predetermined, preferably horizontal direction or to the vertical. In addition, the rotary laser 100 preferably has at least one inclination adjustment unit 182, which is designed to adjust the rotary head 160, in particular the beam diverter 165, and/or the laser unit 130, depending on a position determined by the at least one inclination sensor 184, preferably an inclination of the laser unit 130 and/or the rotary head 160, preferably in the vertical direction. Illustratively, the at least one inclination sensor 184 and the at least one inclination adjustment unit 182 form a leveling unit 180.

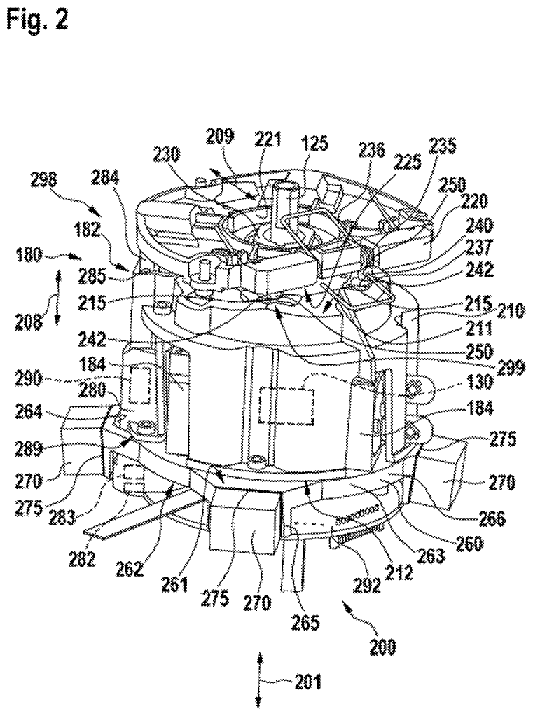

FIG. 2 shows the spindle 125 of the rotary laser 100 from FIG. 1 with the laser unit 130 and the leveling unit 180. The spindle 125 is illustratively mounted in a base plate 220 via a ball joint 230. Preferably, the base plate 220 is fixed to the housing, i.e., it is immovably fixed to the housing 110 of the rotary laser 100 of FIG. 1. Alternatively, the base plate 220 is formed integrally with the housing 110 of the rotary laser 100 of FIG. 1. The base plate 220 preferably has a central recess 221 in which at least part of the ball joint 230 is arranged.

A carrier plate 260 is arranged, for example, on an illustrative lower side 225 of the base plate 220. The carrier plate 260 is preferably arranged at a predetermined distance from the base plate 220. The carrier plate 260 preferably has a disc-shaped base body 266. Furthermore, the carrier plate 260 has a top side 261 facing the base plate 220 and a bottom side 262 facing away from the base plate 220. The leveling unit 180, the laser unit 130, and/or a control board 292 associated with the electronic unit 190 of FIG. 1 are preferably arranged on the carrier plate 260.

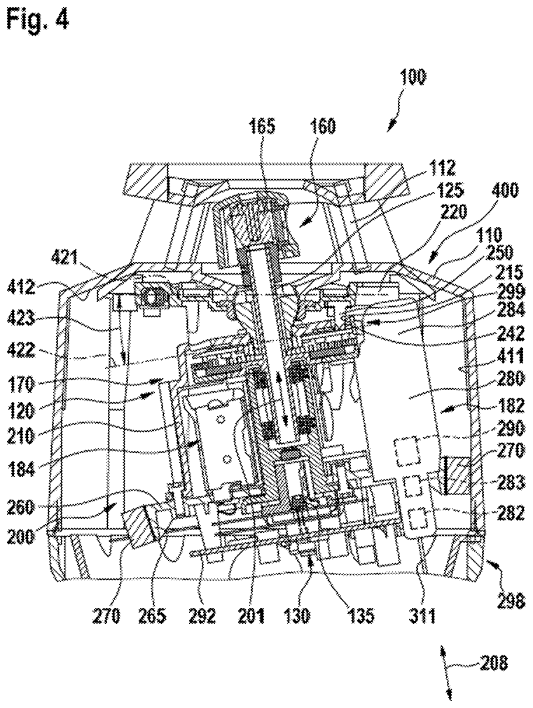

The at least one inclination adjustment unit 182 associated with the leveling unit 180 is preferably designed to adjust an inclination angle (423 in FIG. 4) of the support plate 260 relative to the base plate 220 fixed to the housing. The at least one inclination adjustment unit 182 is arranged in sections in a recess 264 of the carrier plate 260. Furthermore, the at least one inclination adjustment unit 182 is illustratively fixed to the carrier plate 260 by way of a screw connection 289, in particular on the top side 261 of the carrier plate 260 facing the base plate 220.

The at least one inclination adjustment unit 182 is preferably assigned a protective element 290 for protection in the event of an overload. In the context of the present disclosure, an overload event comprises at least one unintentional tipping over or falling of the rotary laser 100 onto a surface, in which the carrier plate 260 swivels uncontrollably.

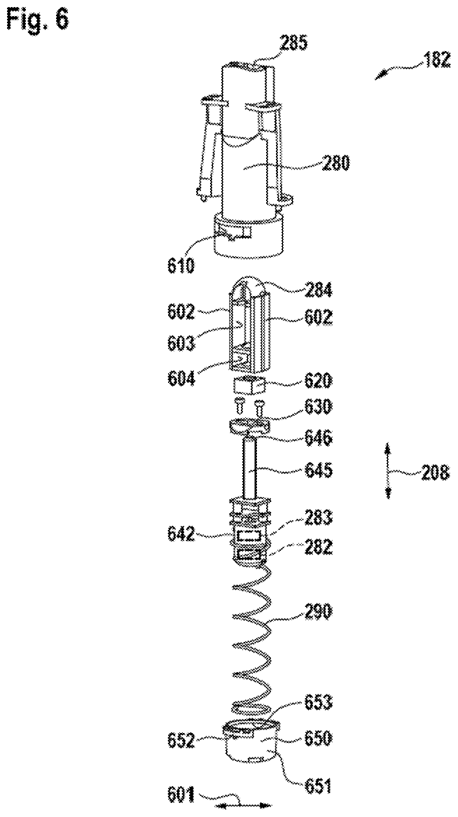

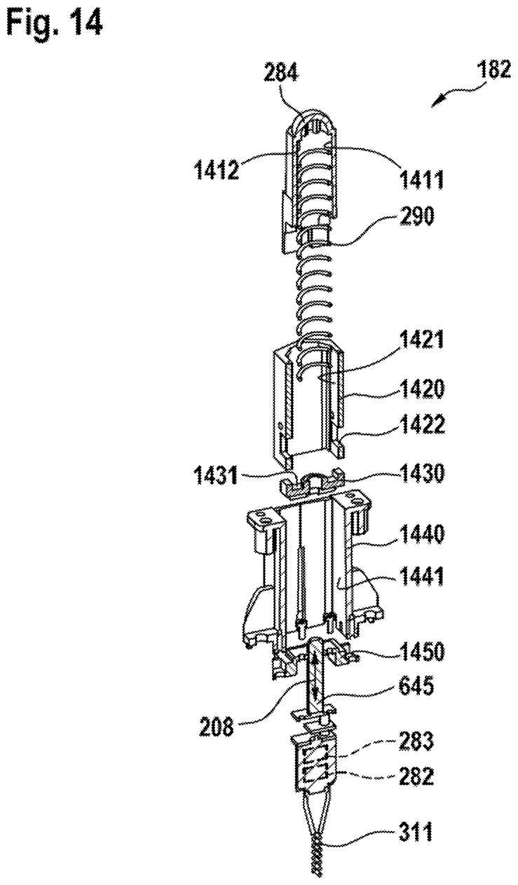

The at least one inclination adjustment unit 182 preferably has an inclination adjustment unit housing 280 (and 1440 in FIG. 14). The inclination adjustment unit housing 280 preferably contains at least one motor 282 with a drive spindle (645 in FIG. 6) for displacing a ram 284 along a longitudinal extension 208 of the drive spindle (645 in FIG. 6) or along a longitudinal extension 201 of the spindle 125. Preferably, the motor 282 is a DC motor. The tappet 284 preferably abuts against the base plate 220 fixed to the housing. By displacing the tappet 284 along the longitudinal extension 208, a predetermined inclination angle (423 in FIG. 4) of the carrier plate 260 relative to the base plate 220 fixed to the housing can preferably be adjusted. The tappet 284 is preferably arranged so that it can be moved in an interior receptacle 285 of the inclination adjustment unit housing 280. Alternatively or optionally, a gear 283 is assigned to the inclination adjustment unit 182.

Preferably, the protective element 290 is arranged within the inclination adjustment unit housing 280 (and 1440 in FIG. 14) of the inclination adjustment unit 182. Preferably, the protective element 290 is designed as a spring element. The protective element 290 is preferably arranged on the drive side and/or output side of the motor 282.

Preferably, the carrier plate 260 has a laser assembly 200. The laser assembly 200 preferably comprises at least the laser unit 130, the drive unit 120 of the rotary laser 100 of FIG. 1, the leveling unit 180, and/or a control board 292 associated with the electronic unit 190 of FIG. 1. The laser assembly 200 is illustratively arranged at least in sections on the carrier plate 260. In addition, the carrier plate 260 optionally has a housing 210. The housing 210 is arranged, for example, with its bottom side 212 facing the carrier plate 260 on the top side 261 of the carrier plate 260 facing the base plate 220. Preferably, the housing 210 is fastened to the carrier plate 260 by way of a screw connection. At least the one inclination sensor 184 of the leveling unit 180 and/or the drive unit 120 are arranged in the housing 210 for illustrative purposes.

Preferably, an actuation element 235 is provided, which is preferably arranged facing the at least one inclination adjustment unit 182. The actuation element 235 is preferably designed to act upon the carrier plate 260 to return it to an initial position after the ram 284 has been displaced. Preferably, the actuation element 235 is designed as a spring element, in particular as a double-leg spring with a first and second leg 236, 237. Illustratively, the second leg 237 is arranged on the top side 211 of the housing 210 associated with the carrier plate 260.

Preferably, an end stop unit 299 with at least one contact element 250 is provided. The end stop unit 299 is preferably designed to deactivate the inclination adjustment unit 182 when a maximum possible inclination angle (423 in FIG. 4) is reached. The at least one contact element 250 is preferably electrically conductive. Preferably, in the event of an overload, the at least one contact element 250 is elastically deformable in order to protect a laser assembly 200. Preferably, the at least one contact element 250 is both deformable and at least partially electrically conductive. Preferably, the at least one contact element 250 is arranged on the base plate 220 fixed to the housing by way of a transfer molding process or an injection molding process. Alternatively, the at least one contact element 250 can be glued to the base plate 220.

Preferably, at least sections of the housing 210 accommodate the laser unit 130, the spindle 125, the at least one inclination sensor 184, and/or the at least one inclination adjustment unit 182. The housing 210 has, on its top side 211 facing the base plate 220, an illustrative recess 215 assigned to the at least one contact element 250. The at least one recess 215 is exemplarily designed to partially penetrate and contact a contact surface 242 assigned to a control board 240. Preferably, at least one, i.e., the contact surface 242, is provided, wherein the contact surface 242 may be formed in an annular shape. Alternatively, several contact surfaces may be provided, which may be formed as ring segments. Alternatively, several contact surfaces are assigned to a contact element 250 and/or several contact elements 250 are assigned to a contact surface.

By touching the contact surface 242 of the control board 240 with the contact element 250, the motor 282 of the inclination adjustment unit 182 can preferably be deactivated. Preferably, the contact surface 242 and the inclination adjustment unit 182 are spaced apart from each other in the radial direction 209 of the spindle 125. Alternatively or optionally, the motor 282 of at least one inclination adjustment unit 182 is designed such that, when a maximum possible inclination angle (423 in FIG. 4) is reached, the direction of rotation of the motor 282 can be changed to reduce the inclination angle (423 in FIG. 4).

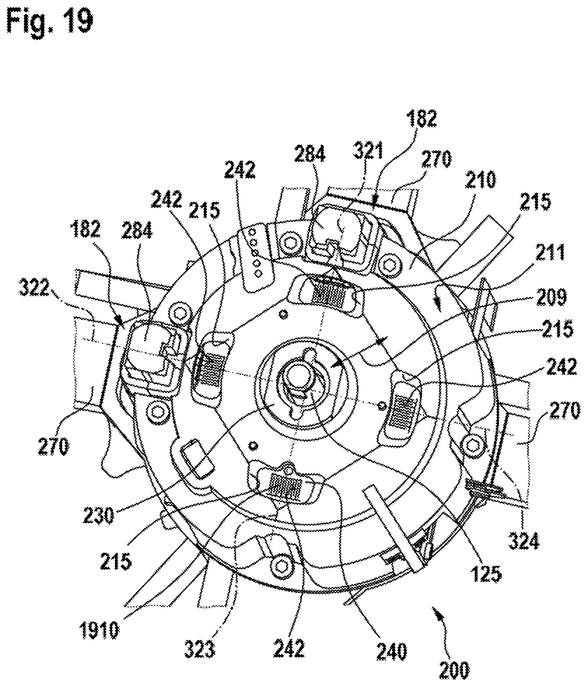

The control board 240 is illustratively assigned to the electronic unit 190 of FIG. 1. In particular, the control board 240 is exemplarily assigned to the drive unit 120 of FIG. 1. Preferably, the control board 240 is arranged on a top side 261 of the carrier plate 260 facing away from the base plate 220, illustratively facing the base plate 220. Preferably, the contact surface 242 is designed as a meander contact (1910 in FIG. 19).

Preferably, an overload protection device 298 is provided to protect the laser assembly 200 in the event of an overload. Preferably, at least one damping protective element 270 is arranged on an outer circumference 263 of the carrier plate 260, which is associated with the overload protection device 298. The at least one damping protective element 270 is preferably arranged at least in sections on the outer circumference 263 of the carrier plate 260. Here, the at least one damping protective element 270 is illustratively designed as an extension of the carrier plate 260 in the radial direction 209. Alternatively, a damping protective element 270 is arranged along the entire outer circumference 263 of the carrier plate 260. The at least one damping protective element 270 preferably comprises damping foam.

Preferably, the carrier plate 260 has at least one fastening portion 265 on its outer circumference, which extends the carrier plate 260 along the longitudinal extension of the spindle 125. For illustrative purposes, the carrier plate 260 is extended in the direction of the control board 292. Preferably, the at least one damping protective element 270 is arranged, in particular fastened, on the fastening portion 265.

For illustrative purposes, three damping protective elements 270 are arranged on the outer circumference 263 of the carrier plate 260. The three damping protective elements 270 are designed in a cuboid shape as an example. It should be noted that the three damping protective elements 270 shown in the illustration can also have any other shape, e.g., that of an ellipsoid.

Preferably, an adhesive 275 is assigned to the at least one damping protective element 270 to form an adhesive bond with the carrier plate 260 and/or the housing 110. Alternatively or optionally, the protective element 290 is assigned to the overload protection device 298. Furthermore, alternatively or optionally, the contact element 250 is assigned to the overload protection device 298.

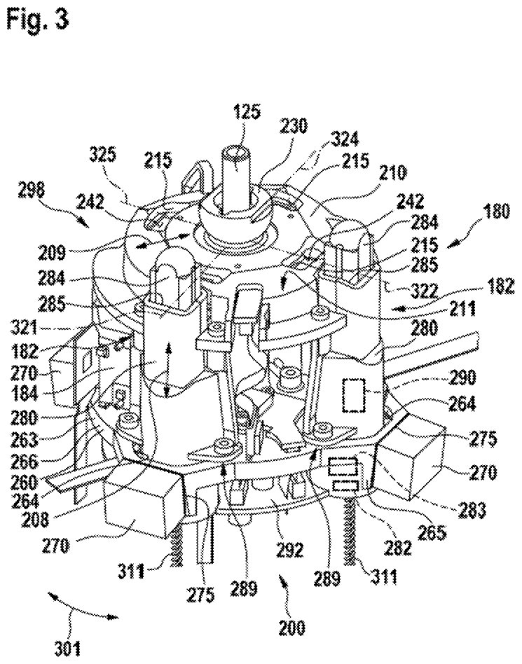

FIG. 3 shows the carrier plate 260 with the laser assembly 200 and the housing 210 from FIG. 2, which is arranged twisted along a circumferential direction 301 of the carrier plate 260 compared to FIG. 2. FIG. 2 illustrates two inclination adjustment units 182 associated with the laser assembly 200. The two inclination adjustment units 182 are preferably designed to be at least substantially identical. Each inclination adjustment unit 182 is illustratively associated with a power cable 311.

Furthermore, four contact surfaces 242 are provided as examples in FIG. 3. Here, two contact surfaces 242 are preferably arranged on each common radial axis 321, 322. Preferably, one inclination adjustment unit 182 is also arranged on each radial axis 321, 322. The respective contact surface 242 and the inclination adjustment unit 182 are preferably arranged at a distance from each other in the radial direction 209. In particular, the respective contact surface 242 is illustratively arranged in the radial direction 209 between the spindle 125 and the inclination adjustment unit 182. Preferably, the two radial axes 321, 322 are arranged adjacent to each other. Illustratively, the two axes 321, 322 are arranged at a distance of 90° from each other. Preferably, a radial axis 324 is arranged diametrically facing the radial axis 321 and/or a radial axis 325 is arranged diametrically facing the radial axis 322. Preferably, each of the radial axes 324, 325 is assigned a respective contact surface 242.

FIG. 4 shows the rotary laser 100 from FIG. 1 with the housing 110, which illustratively has an interior receptacle 412 in which the base plate 220 and the carrier plate 260 with the laser unit 200 are arranged. FIG. 4 illustrates an end stop position 400 of the laser assembly 200. By displacing the ram 284 of the inclination adjustment unit 182 along the longitudinal extension 208 of the drive spindle (645 in FIG. 6), or along a longitudinal extension 201 of the spindle 125, a predetermined inclination angle 423 of the carrier plate 260 relative to the base plate 220 fixed to the housing can be adjusted. Illustratively, the inclination angle 423 is formed or set between an axis 421 associated with the base plate 220 and an axis 422 associated with the carrier plate 260.

Alternatively or optionally, at least one damping protective element 270 of FIG. 2 is arranged on an inner circumference 411 of the housing 110 of the rotary laser 100 assigned to one of the inner receptacles 412. In this case, the damping protective element 270 is formed completely on the inner circumference 411 in the circumferential direction, or at least in sections on the inner circumference 411. As described above, the damping protective element 270 is assigned to the overload protection device 298 of FIG. 2. In the end stop position 400 shown in FIG. 4, the damping protective element 270 arranged on the carrier plate 260 preferably rests on the inner circumference 411 of the housing 110 and/and/or the damping protective element 270 arranged on the inner circumference 411 of the housing 110 rests on the outer circumference 263 of the carrier plate 260.

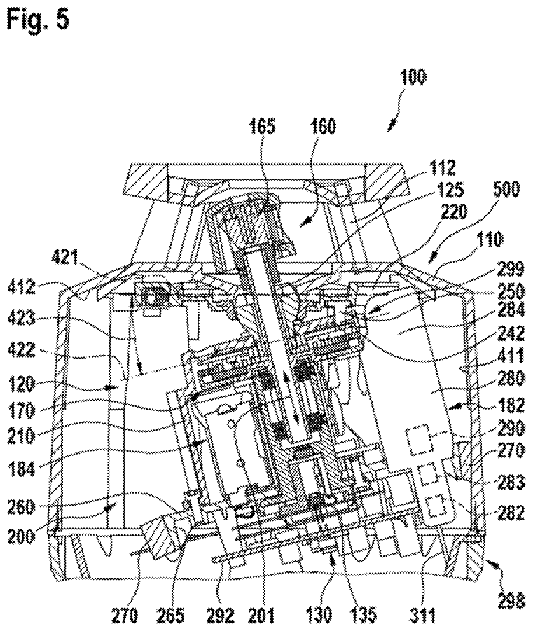

FIG. 5 shows the rotary laser 100 from FIG. 1 with the base plate 220, as well as the carrier plate 260 with the laser unit 130 from FIG. 4, and illustrates an overload position 500 of the laser assembly 200, in which the rotary laser 100 falls, for example, onto its illustrative right side. In this case, the illustrative right-hand damping protective element 270 arranged on the carrier plate 260 is compressed, thereby preventing the carrier plate 260 from striking the housing 110 and thus preventing destruction or damage to the laser assembly 200. In particular, this prevents destruction of the control board 292, the inclination adjustment unit 182, the drive unit 120, and/or the laser unit 130.

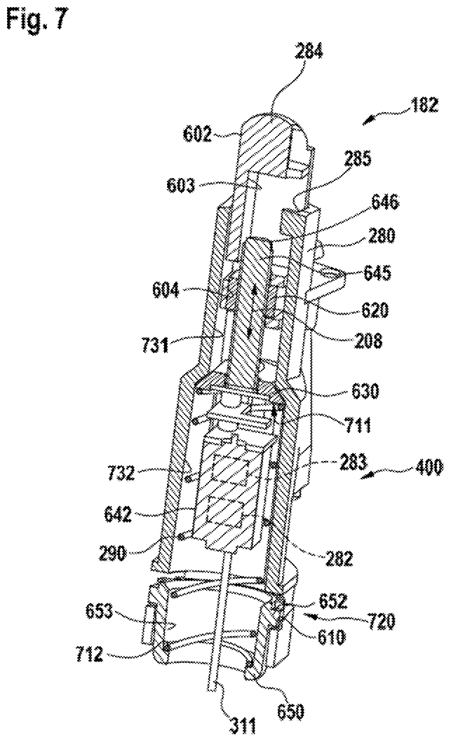

FIG. 6 shows the inclination adjustment unit 182 from FIG. 1 to FIG. 5 with the inclination adjustment unit housing 280, the tappet 284, the motor 282, the gear 283, and the protective element 290. The gear 283 is preferably a spur gear. As described above, the inclination adjustment unit housing 280 has an interior receptacle 285 in which the tappet 284 is slidably arranged. At an illustrative lower region, the inclination adjustment unit housing 280 illustratively has a recess 610. A cap 650 is assigned to the illustrative lower region, which illustratively closes the inclination adjustment unit housing 280 at the bottom. The cap 650 has, for example, an interior receptacle 653 and an outer circumference 651, on which at least one extension part 652 is illustratively arranged. The extension part 652 extends the cap 650, for example, in the radial direction 601. Preferably, the cap 650, in particular the extension part 652, forms a bayonet connection (720 in FIG. 7) with the recess 610 of the inclination adjustment unit housing 280.

Furthermore, FIG. 6 illustrates a drive spindle 645 of the motor 282 of the inclination adjustment unit 182. Preferably, the drive spindle 645 has an external thread in sections. Preferably, the external thread of the drive spindle 645 is a fine thread. At its end facing away from the motor 282, the drive spindle 645 has, for example, a step 646.

The tappet 284 preferably has a first, illustratively upper, receptacle 603 and a second, illustratively lower, receptacle 604. Furthermore, the tappet 284 preferably has two lateral guide surfaces 602.

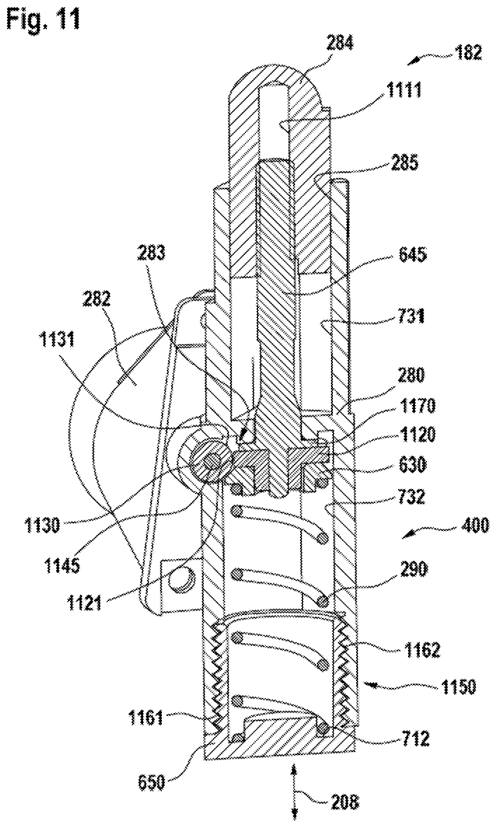

Preferably, the tappet 284 is operatively connected to the drive spindle 645 by way of a screw connection. Preferably, a threaded insert 620 (and 1430 in FIG. 14) or an internal thread (1111 in FIG. 11) is assigned to the tappet 284. In the event of overload, the drive spindle 645 is preferably separated from the threaded insert 620 or the internal thread (1111 in FIG. 11). In this case, the gradation 645 decouples the drive spindle 645 from the threaded insert 620 or the internal thread (1111 in FIG. 11) in the event of overload. Preferably, the gradation 645 has no thread. When the drive spindle 645 leaves the threaded insert 620, the step 646 of the drive spindle 645 preferably serves to allow the drive spindle 645 to be turned back into the threaded insert 620.

Preferably, the threaded insert 620 is assigned to the illustrative lower receptacle 604. Preferably, the threaded insert 620 has a cuboid base body. Furthermore, the drive spindle 645 is assigned, for example, a guide part 630 for guiding in the inclination adjustment unit housing 280. The guide part 630 preferably supports the motor 282

Preferably, the protective element 290, which is designed as a spring element, is arranged coaxially with the drive spindle 645. Preferably, the protective element 290 is aligned coaxially with the longitudinal extension 208 of the drive spindle 645, or aligned in the longitudinal direction of the drive spindle 645. For illustrative purposes, the protective element 290 is arranged on an outer circumference 642 of the motor 282. The motor 282 is preferably arranged along a longitudinal extension 208 of the drive spindle 645.

FIG. 7 shows the inclination adjustment unit 182 of FIG. 6 in the end stop position 400 of FIG. 4. The threaded insert 620 is illustratively arranged in the receptacle 604 of the inclination adjustment unit housing 280. The drive spindle 645 is preferably operatively connected to the threaded insert 620 via its thread, so that rotation of the drive spindle 645 displaces the tappet in the longitudinal direction 208 of the drive spindle 645 in the interior receptacle 285 of the inclination adjustment unit housing 280. The interior receptacle 285 preferably has an illustrative upper interior receptacle 731 that widens into an illustrative lower interior receptacle 732. The tappet 284 is arranged, for example, at least in sections in the illustrative upper interior space 731.

The protective element 290 is preferably arranged in the lower interior space 732 of the inclination adjustment unit housing 280 of the inclination adjustment unit 182, which is assigned to the motor 282, as shown in FIG. 7. The guide part 630 is also preferably arranged in the illustrative lower interior space 732. Furthermore, the protective element 290 is arranged, for example, between a bottom side 711 of the guide part 630 facing the motor 282 and an abutting edge 712 facing the interior receptacle 653 of the cap 650.

Furthermore, FIG. 7 illustrates an exemplary bayonet connection 720 of the cap 650 with the inclination adjustment unit housing 280. The extension part 652 of the cap 650 preferably forms the bayonet connection 720 with the recess 610 of the inclination adjustment unit housing 280.

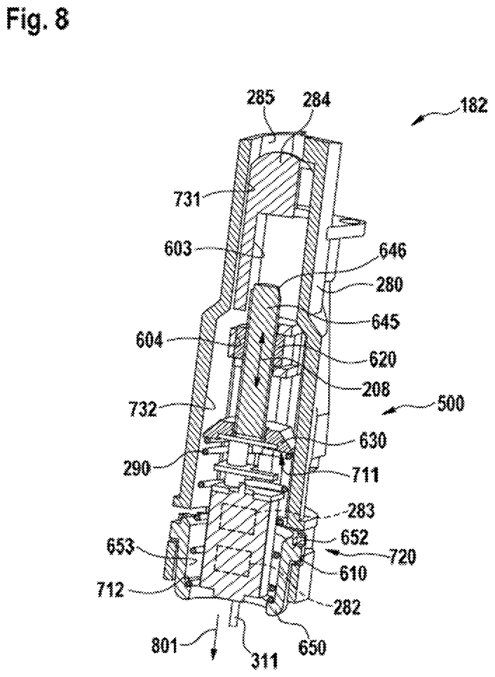

FIG. 8 shows the inclination adjustment unit 182 of FIG. 7 in the overload position 500 of FIG. 5, wherein, according to FIG. 8, the overload case is triggered, for example, by the rotary laser 100 of FIG. 1 falling onto a surface. In this case, the laser assembly 200 swings to the right and the tappet 284 deflects downward, as illustrated. In doing so, the entire assembly consisting of the motor 282, the drive spindle 645, the threaded insert 620, the guide part 630, and the tappet 284 is displaced illustratively downward or along an arrow 801. The tappet 284 is preferably moved into the interior receptacle 285 of the inclination adjustment unit housing 280 or the illustrative upper interior space 731. The protective element 290 is compressed in the process. The loading element 235 of FIG. 2, or the double-leg spring, must have a lower spring rate than the protective element 290 so that the laser assembly 200 is returned to its normal or operating state after the overload event.

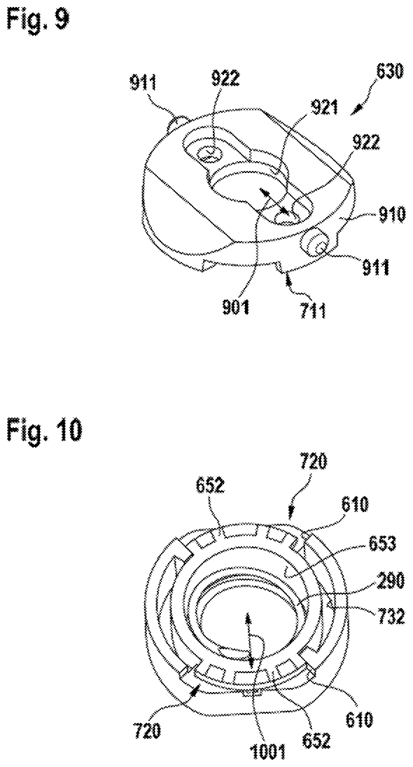

FIG. 9 shows the guide part 630 of the inclination adjustment unit 182 from FIG. 6 to FIG. 8. Preferably, the guide part 630 has a disc-shaped base body with an outer circumference 910. The guide part 630 preferably has at least one, illustratively two, lateral radial extensions 911 on its outer circumference 910. The radial extensions 911 extend the guide part 630 in the radial direction 901. The radial extensions 911 are preferably designed to guide the guide part 630 in corresponding grooves of the inclination adjustment unit housing 280 in the event of overload, thereby preventing the motor 282 from twisting.

For storing the drive spindle 645, the guide part 630 preferably has a central recess 921. In addition, the guide part 630 preferably has at least one, illustratively two, recesses 922 arranged laterally of the recess 921 for connection to the motor 282. The motor 282 is preferably connected to the guide part 630 by way of a screw connection. Alternatively, the guide part 630 can also be formed integrally with the motor 282.

FIG. 10 shows the bayonet connection 720 of FIG. 7 of the cap 650 with the inclination adjustment unit housing 280 of FIG. 2. The extension part 652 of the cap 650 preferably forms the bayonet connection 720 with the recess 610 of the inclination adjustment unit housing 280. As mentioned above, extension part 652 is designed as an extension in the radial direction 1001.

FIG. 11 shows the inclination adjustment unit 182 from FIG. 1, which is designed according to an alternative embodiment. Here, the motor 282 from FIG. 2 is preferably arranged transversely, in particular perpendicularly, to the longitudinal extension 208 of the drive spindle 645 from FIG. 6. The drive spindle 645 is preferably associated with a gear wheel 1120. Illustratively, the gear wheel 1120 is arranged along the longitudinal extension 208 of the drive spindle 645 between the guide part 630 and a circumferential collar 1170 of the drive spindle 645. Preferably, an intermediate shaft 1145 with a gear wheel 1130 is assigned to the motor 282. In normal operation 400 of the motor 282, as shown in FIG. 11, the gear wheel 1120 of the drive spindle 645 is preferably operatively connected to the gear wheel 1130 of the motor 282. For this purpose, gear wheel 1130 illustratively has outer toothing 1131 and gear wheel 1120 has outer toothing 1121.

In addition, the tappet 284 preferably has an internal thread 1111 for connection to the drive spindle 645. Furthermore, the cap 650 has, for example, an external thread 1161, and the inclination adjustment unit housing 280 preferably has an internal thread 1162 for forming a screw connection 1150. Alternatively, the inclination adjustment unit housing 280 has an external thread and the cap 650 has an internal thread to form a screw connection 1150.

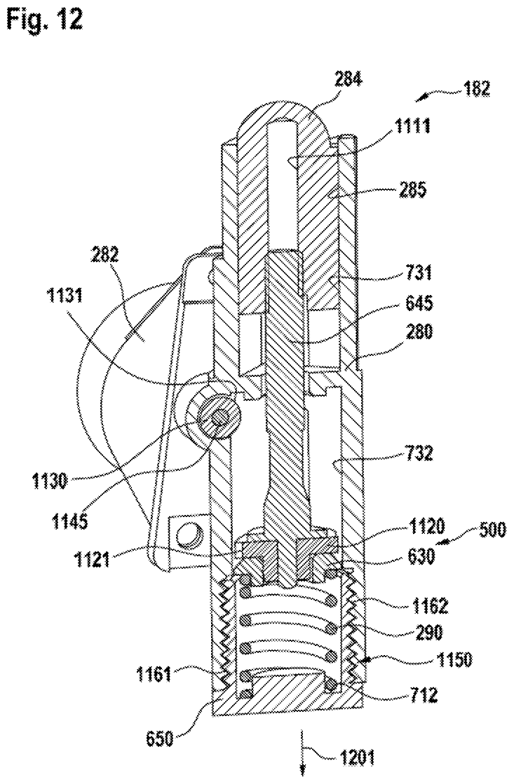

FIG. 12 shows the inclination adjustment unit 182 from FIG. 11 in the event of a fault in motor 282, or in the overload position 500 from FIG. 5. The protective element 290 from FIG. 2 is illustratively compressed, thus separating the gear wheel 1120 of the drive spindle 645 from the gear wheel 1130 of the motor 282, thereby interrupting the transmission of rotary movement from the motor 282 to the drive spindle 645. This also protects the tappet 645, the thread between the tappet 284 and the drive spindle 645, and the drive spindle 645. In the event of an impact from above on the tappet 284, as shown in FIG. 5, the tappet 284 and the drive spindle 645 can deflect against the protective element 290 in the direction of arrow 1201.

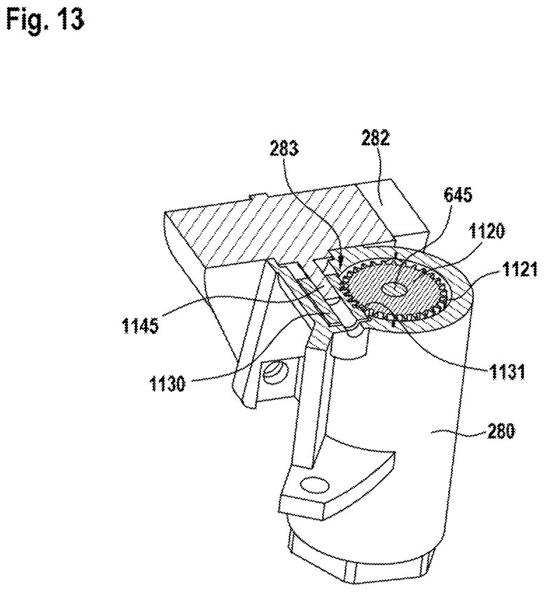

FIG. 13 shows the gear 283 of the inclination adjustment unit 182 from FIG. 11 and FIG. 12. FIG. 13 illustrates the gear wheel 1120 associated with the drive spindle 645, the gear wheel 1130 associated with the motor 282, and the intermediate shaft 1145.

FIG. 14 shows the inclination adjustment unit 182 from FIG. 1, which is designed according to a further embodiment. Here, the protective element 290 is preferably arranged at least in sections in an interior space 1411 of the tappet 284 from FIG. 2. The interior space 1411 is illustratively arranged facing the motor 282.

Furthermore, the tappet 284 is illustratively arranged in an interior receptacle 1421 of a guide element 1420 so as to be movable along the longitudinal extension 208 of the drive spindle 645. The guide element 1420, in turn, is preferably arranged movably along the longitudinal extension 208 of the drive spindle 645 in an interior receptacle 1441 of an inclination adjustment unit housing 1440 of the inclination adjustment unit 182. The drive spindle 645 preferably displaces the tappet 284 along the longitudinal extension 208 of the drive spindle 645 by way of a threaded insert 1430. Here, the threaded insert 1430 is preferably operatively connected to the guide element 1420. Preferably, the guide element 1420 has at least one recess 1422 for this purpose.

The protective element 290 is preferably arranged in the interior 1411 of the tappet 284 coaxially with the drive spindle 645. Furthermore, the protective element 290 is preferably arranged along the longitudinal extension 208 of the drive spindle 645 between an abutting edge 1412 of the interior 1411 of the tappet 284 facing the motor 282 and a bottom surface 1431 of the threaded insert 1430.

In addition, a cover 1450 is provided, for example, which is designed to close the inclination adjustment unit housing 1440 of the inclination adjustment unit 182 at an end opposite to the tappet 284. According to FIG. 14, the motor 282 is arranged outside the inclination adjustment unit housing 1440 of the inclination adjustment unit 182. In FIG. 14, the motor 282 is illustratively arranged below the inclination adjustment unit housing 1440.

The protective element 290 can alternatively or optionally be arranged in the area between the threaded insert 1430 and the cover 1450.

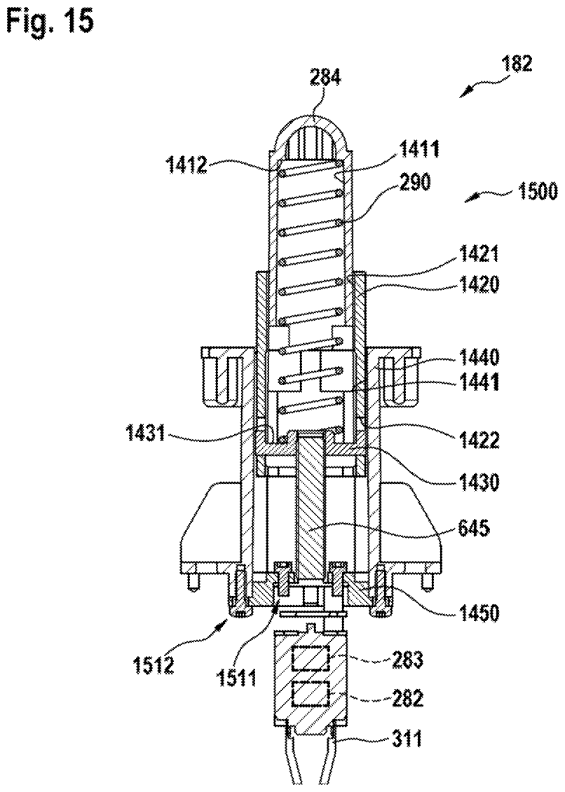

FIG. 15 shows the inclination adjustment unit 182 of FIG. 14 in an extended position 1500. The guide element 1420 is illustratively arranged in sections outside the interior receptacle 1441 of the inclination adjustment unit housing 1440, and the tappet 284 is arranged in sections outside the interior receptacle 1421 of the guide element 1420.

Furthermore, FIG. 15 shows an exemplary screw connection 1511 between the cover 1450 and the motor 282. In addition, FIG. 15 shows an exemplary screw connection 1512 between the cover 1450 and the inclination adjustment unit housing 1440.

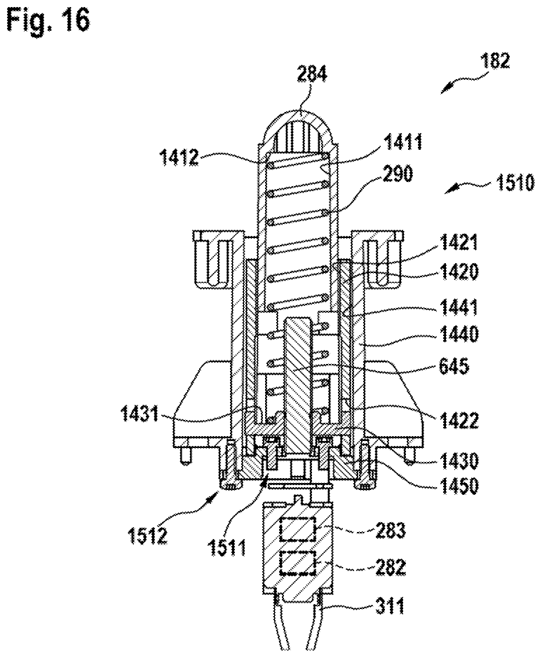

FIG. 16 shows the inclination adjustment unit 182 from FIG. 15 in a retracted position 1510. The guide element 1420 is illustratively arranged completely within the interior receptacle 1441 of the inclination adjustment unit housing 1440, and the tappet 284 is arranged in sections outside the interior receptacle 1421 of the guide element 1420.

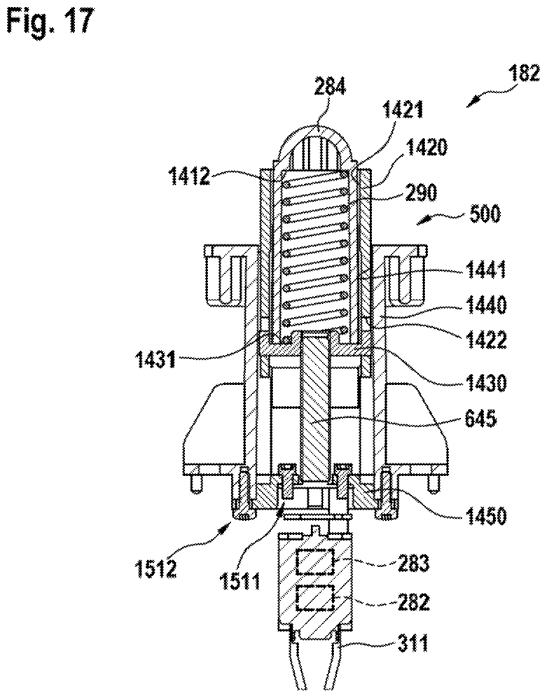

FIG. 17 shows the inclination adjustment unit 182 of FIG. 15 and FIG. 16 in the overload position 500 according to FIG. 5. The guide element 1420 is illustratively arranged in sections outside the interior receptacle 1441 of the inclination adjustment unit housing 1440, and the tappet 284 is arranged as far as possible in the interior receptacle 1421 of the guide element 1420. Here, the protective element 290 is completely compressed for illustrative purposes.

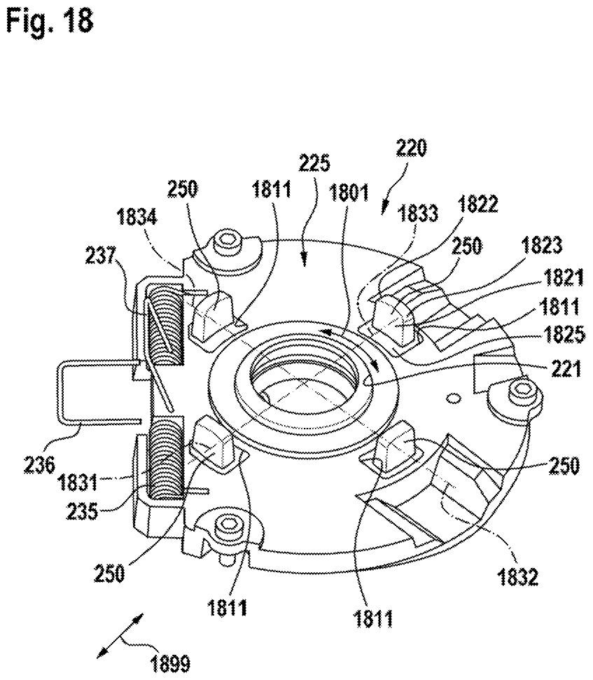

FIG. 18 shows the base plate 220 of FIG. 2 as seen from its side 225. Preferably, the at least one contact element 250 is arranged in an associated recess 1811 of the base plate 220 fixed to the housing. Preferably, the at least one contact element 250 forms a substance-to-substance connection with the recess 1811, e.g. an adhesive connection. Alternatively, the at least one contact element 250 is fixed in the recess 1811 by way of a transfer molding process or an injection molding process. Preferably, the at least one contact element 250 is aligned along the main axes 1831, 1832, 1833, 1834 associated with the base plate 250 fixed to the housing. Preferably, the main axes 1831, 1832, 1833, 1834 are aligned along a radial direction 1899 of the base plate 1899.

The at least one contact element 250 preferably comprises a cuboid base body 1821 with rounded corners 1822, 1823. Preferably, the cuboid base body 1821 is arranged on a base section 1825. The base section 1825 is preferably arranged in the recess 1811, the cuboid base body 1821 being arranged perpendicularly on the base section 1825. In addition, the at least one contact element 250 is bent in the circumferential direction 1801 of the base plate. Alternatively, the base body 1821 can also have any other shape, e.g. cylindrical.

FIG. 19 shows the carrier plate 260 with the laser assembly 200 and the housing 210 of FIG. 3 and illustrates the exemplary four recesses 215 with the contact surfaces 242 arranged on the top side 211. Preferably, each recess 215 is assigned a contact surface 242. Preferably, the contact surface 242 is designed as a meander contact 1910. Illustratively, the contact surface 242 has a meander contact 1910. Alternatively, a contact surface 242 can also have several meander contacts 1910.

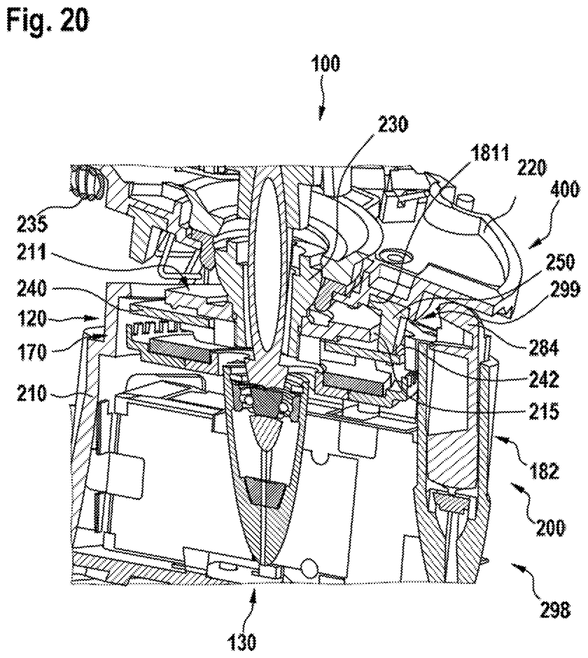

FIG. 20 shows the rotary laser 100 of FIG. 1 and FIG. 4 and illustrates contact between the illustrative right-hand contact element 250 of the base plate 220 and the illustrative right-hand contact surface 242 of the control board 240 of the carrier plate 260. FIG. 20 shows an example of the illustrative right-hand contact element 250 reaching through the recess 215 of the top side 211 of the housing 210.

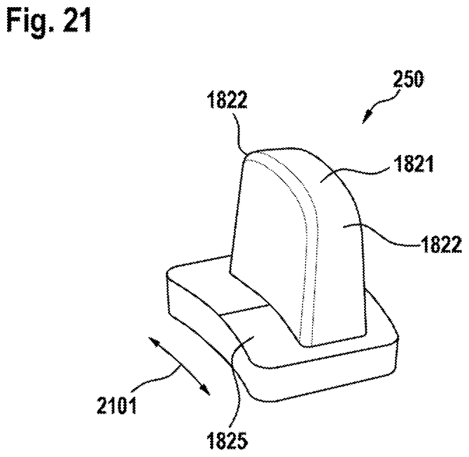

FIG. 21 shows the contact element 250 of the base plate 220 of FIG. 2, FIG. 4, FIG. 18 and FIG. 20 with the base section 1825 and the cuboid base body 1821 with the rounded corners 1822, 1823. Preferably, the contact element 250 is curved along its longitudinal extension 2101.

What is claimed is:

1. A rotary laser, comprising:
a housing;
a base plate fixed to the housing; and
a carrier plate having a laser assembly, the base plate being arranged at a predetermined distance from the carrier plate,
wherein the laser assembly includes (i) at least one laser unit configured to generate a laser beam, and (ii) a leveling unit having at least one inclination adjustment unit configured to adjust an inclination angle of the carrier plate relative to the base plate,
wherein an end stop unit having at least one contact element is provided, which is designed to deactivate the inclination adjustment unit when a maximum possible inclination angle is reached, and
wherein the at least one contact element is electrically conductive.

2. The rotary laser according to claim 1, wherein:
in the event of an overload, the at least one contact element is elastically deformable in order to protect the laser assembly.

3. The rotary laser according to claim 1, wherein an additional housing associated with the carrier plate has a recess on its top side associated with the at least one contact element for partially penetrating and contacting a contact surface assigned to a control board, whereby a motor associated with the at least one inclination adjustment unit can be deactivated.

4. The rotary laser according to claim 3, wherein the contact surface is configured as a meander contact.

5. The rotary laser according to claim 1, wherein the at least one contact element is deformable and electrically conductive at least in sections.

6. The rotary laser according to claim 1, wherein the at least one contact element has a cuboid base body with rounded corners and/or is bent along its longitudinal extension.

7. The rotary laser according to claim 1, wherein the at least one contact element is glued into an associated recess of the base plate fixed to the housing.

8. The rotary laser according to claim 1, wherein the at least one contact element is arranged on the base plate fixed to the housing by way of a transfer molding process or injection molding process.

9. The rotary laser according to claim 1, wherein the at least one contact element is aligned along main axes associated with the base plate.

10. The rotary laser according to claim 1, wherein:
two inclination adjustment units are provided and four contact surfaces are provided,
two contact surfaces are arranged on a common radial axis each having one inclination adjustment unit, and
the respective contact surface and the inclination adjustment unit are arranged at a distance from each other in the radial direction.

11. The rotary laser according to claim 1, wherein a motor associated with the at least one inclination adjustment unit is designed such that, when a maximum possible inclination angle is reached, the direction of rotation of the associated motor is changed to reduce the inclination angle.
